(19) United States
(12) Patent Application Publication
(10) Pub. No.: US 2024/0024903 A1
(43) Pub. Date: Jan. 25, 2024

(54) SEALED ASSEMBLY FOR A FLEXIBLE PUMPING MEMBRANE AND A RIGID END PIECE OF A PUMP OF A SYSTEM FOR AIRLESS DISPENSING OF A LIQUID OR PASTE PRODUCT

(71) Applicant: CEP, Saint-Rémy sur Durolle (FR)

(72) Inventor: Géry DAMBRICOURT, La Verchère (FR)

(21) Appl. No.: 18/040,795

(22) PCT Filed: May 31, 2021
(86) PCT No.: PCT/FR2021/050979

§ 371 Date: Feb. 6, 2023

(30) Foreign Application Priority Data
Aug. 6, 2020 (FR) FR2008344

(51) Int. Cl. B05B 11/10; B05B 11/00

(52) U.S. Cl. CPC B05B 11/1035; B05B 11/007; B05B 11/0072; B05B 11/0013; B05B 11/1069

(57) ABSTRACT

The invention relates to a system (S) for dispensing a product, comprising a pump (P) with a flexible pumping bellows, a lower-end flexible tubular wall section of which is automatically assembled on a chimney of a rigid end piece by interlocking of two complementary hooks, ensuring a sealed connection by pressing together of two complementary annular surfaces.

### TECHNICAL FIELD OF THE INVENTION

The present invention relates to an airless dispensing system, that is to say one without air intake so that the dispensed product is never in contact with the air before it is dispensed. The precise dosage of the quantity of product dispensed during each use is ensured by means of a pump integrated into the system.

The invention relates more particularly to a sealed assembly of a flexible tubular wall section forming an end of a flexible pumping membrane, and of a rigid end piece belonging to the pump.

### TECHNICAL BACKGROUND

An airless dispensing system is used in particular for dispensing products that are likely to deteriorate in contact with air. These may be pharmaceutical products or cosmetic products such as care creams, of fluid consistency, i.e. liquid or paste products.

The fluid is packaged in a container, whose volume, at any time of use, corresponds precisely to the remaining amount of the product that it contains, as the product is never in contact with air inside the container.

In a known manner, such a dispensing system comprises a pump provided with a variable volume dispensing chamber provided with an inlet connected to the container, and an outlet for discharging the air-sensitive product to be dispensed.

There are many means for varying the volume of the dispensing chamber.

A precise dispensing system of known design, and such as for example described in document WO 2017/051126 A1, consists of actuating a piston by a forward-and-return movement in a cylinder.

The opening and closing movements at the inlet and at the outlet of the dispensing chamber are made by means of valves consisting of rigid movable balls or plugs.

A conventional pump, the dispensing chamber of which is made up of a piston sliding in a cylinder, allows for precise metering of the dispensed quantity of the fluid, thereby making it possible to avoid an imprecise or excessive use of the packaged product in the container.

Such a type of dispensing system is composed of a large number of parts and components, which complicates manufacture and assembly, and increases its cost, particularly when the system is airtight from the container to the product outlet port.

In order to vary the volume of the dispensing chamber, another solution consists of an airless dispensing system which comprises a lower container that contains the product and an upper pump which is mounted on the container and comprises a rigid end piece that is mounted at the upper end of the container and comprises a central chimney provided with a channel to allow through the product to be dispensed.

The pump also comprises a push-button which is slidably mounted relative to the rigid end piece between a high rest position and a low actuation position.

The upper part of the push-button comprises an outlet port for the product.

Instead of a cylinder-piston assembly, the pump comprises a flexible fluid pumping membrane that is shaped like a bellows for pumping the product.

The flexible membrane comprises an upper end section which is secured to the push-button by a sealed connection and a lower end section which is secured to the rigid end piece by a sealed connection.

The assembly and securing by sealed connections of the two opposing end sections of the pumping membrane, also called the pumping bellows, must satisfy many parameters and requirements.

Indeed, during actuation of the dispensing system, the product dispensing chamber formed inside the bellows must withstand high pressures that can reach 2 (two) bars, i.e. a value on the order of ten times the trigger threshold value of the internal plugs of the pump.

Such pressures inside the bellows are likely to cause leaks, or even separation of the end of the bellows from its associated component, the lower rigid end piece or upper push-button.

For this purpose and in a known manner, and as illustrated for example in document FR2671330A1, each sealed connection requires the implementation of techniques for assembling each end section by axial interlocking with radial clamping in a housing complementary to the end piece and to the push-button respectively.

Such assembly designs and techniques do not allow for a fast-paced, simple, automated industrial implementation.

In particular, they initially require the assembly of each end section of the flexible pumping bellows in a complementary part of the end piece and of the push-button respectively, followed by the sliding assembly of the push-button on the rigid end piece.

Indeed, carrying out the assembly steps in the aforementioned order is impossible when the push-button and the rigid end piece are each formed of a single part and the two parts slide one inside the other by forming a closed assembly prior to the assembly of at least one end section of the pumping bellows.

The object of the invention is to propose an assembly, sealed under high pressure, of a flexible tubular wall section forming one end (for example the lower end) of a flexible pumping membrane and a rigid end piece, this sealed assembly being designed to be assembled automatically by the effect of the mounting of the push-button on the rigid end piece.

### SUMMARY OF THE INVENTION

The invention proposes a sealed assembly, along a vertical axis oriented from bottom to top,
of a flexible tubular wall section forming the lower end of an upper flexible membrane capable of being compressed along the vertical axis of the assembly, and of a rigid end piece,
characterized in that:
a) the flexible tubular wall section comprises, successively and axially from top to bottom along the axis:
a1) an upper portion with at least one first sealing surface;
a2) an intermediate portion with an inner face of the flexible tubular wall; a3) a first retaining hook arranged at the lower end of the flexible tubular wall section, and in that:
b) the rigid end piece comprises:
b1) a central chimney which is capped and at least partially surrounded by the flexible tubular wall section and which comprises successively and axially from top to bottom along the axis:
b11) an upper portion in which the central chimney has a second sealing surface that mates with the first sealing surface of the upper portion;
b12) an intermediate portion with an outer face which is distant from the inner face of the intermediate portion of the flexible tubular wall section, so as to provide a space between said inner face and said outer face;
b2) and a second hook which mates with the first hook to hold the upper portion of the flexible tubular wall section pressed, along the vertical axis, on the upper portion of the central chimney.

According to a first embodiment, such a sealed assembly is characterized in that:
the upper portion of the flexible tubular wall section consists of an upper axial wall, an inner face of which in the form of a downward-flared truncated cone is the first sealing surface;
the upper portion of the central chimney has a downward-flared truncated cone shape, a lateral face of which is the second sealing surface;
the first sealing surface rests on the second sealing surface, along the vertical axis.

According to this first embodiment, the sealing function and the pressing, along the vertical axis, of the upper portion of the flexible tubular wall section on an upper portion of the central chimney are ensured by the mating of the two sealing surfaces which are in a sealed axial abutment.

According to a second embodiment, such a sealed assembly is characterized:
in that the upper portion of the flexible tubular wall section comprises successively, in a horizontal direction oriented outward from the vertical axis:
an inner tubular axial bushing, a lateral face of which is the first sealing surface;
and the upper axial wall providing the connection with the intermediate portion of the flexible tubular wall section;
in that the upper portion of the central chimney comprises a tubular axial housing open axially upward, wherein the inner tubular axial bushing is axially housed, a lateral face of which is the second sealing surface;
and in that:
the upper portion of the flexible tubular wall section comprises a first bearing face oriented downward and delimited in said horizontal direction between the inner tubular axial bushing and the upper axial wall;
the upper portion of the central chimney comprises a second bearing face oriented upward;
and the first bearing face is supported on the second bearing face along the vertical axis.

According to this second embodiment, the sealing function and the pressing, along the vertical axis, of the upper portion of the flexible tubular wall section on an upper portion of the central chimney are ensured separately by the mating of the two sealing surfaces and by the pressing together of the two bearing surfaces.

According to other features of the sealed assembly:
the first hook comprises a frustoconical annular retaining face oriented upward and flared downward which is in abutment, along the vertical axis, against a complementary frustoconical retaining annular face, oriented downward and flared downward, belonging to the second hook,
the sealed assembly is characterized in that the thickness of the upper axial wall is greater than the thickness of the intermediate portion of the flexible tubular wall section;
the space between said inner face and said outer face extends opposite the entire axial height of the intermediate portion of the flexible tubular wall section;
the thickness of said upper portion of the flexible tubular wall section is greater than the thickness of the intermediate portion of the flexible tubular wall section;
the upper portion of the flexible tubular wall section comprises an outer stiffening ring which is arranged axially in a horizontal plane perpendicular to the vertical axis located at the upper end of this upper portion of the flexible tubular wall section;
the intermediate portion of the flexible tubular wall section has a downward-flared frustoconical shape;
the intermediate portion of the flexible tubular wall section is delimited by a downward-flared frustoconical inner face, and the intermediate portion of the central chimney is delimited by a cylindrical outer lateral face;
the half-angle at the top of said concave inner surface and said convex outer surface are equal and are less than or equal to twenty degrees;
the first hook is a continuous annular hook and the second hook is an annular hook divided into a plurality of sectors;
in a horizontal direction oriented outward from the vertical axis of the assembly, the assembly successively comprises the first hook which is oriented outward, and the second hook which is oriented inward;
the sealed assembly comprises at least one annular ramp formed on the first hook and/or on the second hook in order to cause a deformation of the intermediate portion of the flexible tubular wall section allowing an axial crossing of the second hook by the first hook during the assembly of the flexible tubular wall section and the rigid end piece;
the rigid end piece comprises a tubular skirt which surrounds the central chimney, and in that the second hook is arranged at an upper end of this skirt,
the lateral skirt and the second hook are divided into several sectors separated by axial slots;
the upper flexible membrane is shaped like a consecutive-bend bellows capable of being compressed along the axis of the assembly;
the upper flexible membrane is made of a low-density polyethylene, the density of which is less than or equal to 0.900.

The invention also proposes an airless dispensing system for a liquid or paste product which comprises a lower container that contains the product and an upper pump that is mounted on the container and that comprises:
a rigid end piece that is mounted at the upper end of the container and comprises a central chimney provided with an axial product passage channel;
a push-button that is slidably mounted relative to the rigid end piece between a high rest position and a low actuation position, and the upper part of which comprises an outlet for the product;
and a flexible membrane, shaped like a pumping bellows for the product, an upper end section of which is secured to the push-button by a sealed connection and a lower end section of which is fixed to the rigid end piece,
   characterized in that the lower end section and the rigid end piece form a sealed assembly according to the invention.

The invention also provides a method for assembling a dispensing system according to the invention, characterized in that it comprises the successive steps consisting of producing the pump:
e1) by axially assembling the flexible membrane, shaped like a pumping bellows, and the push-button by securing its upper end section to the push-button;
e2) and by axially assembling the rigid end piece and the push-button by automatically performing the assembly and securing said section of the flexible membrane by a sealed connection on the rigid end piece during the mounting of the push-button on the rigid end piece, by axial crossing of the second hook by the first hook, by placing the upper portion of the flexible tubular wall section bearing, along the vertical axis, on the upper portion of the central chimney and by making the first sealing surface and the second sealing surface mate in a sealed manner.

In the low actuation position of the push-button, the pumping bellows is compressed in an intermediate state between a first extreme state before compression and a second extreme crushed state.

Surprisingly, in an intermediate compression state or position, the pumping bellows induces a bearing force of the flexible tubular wall section on the central chimney which is sufficient to simultaneously allow the axial crossing of the second hook by the first hook, and the sealed pressing of the two complementary sealing surfaces.

### BRIEF DESCRIPTION OF THE FIGURES

Further features and advantages of the invention will become apparent from the following detailed description, which may be understood with reference to the attached drawings in which:

FIG. 1 is a perspective and cross-sectional view by an axial plane of a dispensing assembly according to a first embodiment of the invention;

FIG. 2 is a cross-sectional view of the flexible pumping membrane of the assembly shown in FIG. 1;

FIG. 3 is a cross-sectional view at large scale which illustrates the flexible pumping membrane and the rigid end piece in a relative vertical position corresponding to a phase of the assembly of these two elements which is prior to the mutual hooking thereof;

FIG. 4 is a detailed view at a larger scale of a part of the two elements illustrated in FIG. 3 which are shown in the assembled relative position in which the two hooks are pressing against each other;

FIG. 5 is a view of a part of the two elements illustrated in FIGS. 3 and 4 which are shown in a state corresponding to a low actuation position of the push-button, the pumping bellows being compressed in an intermediate state between a first extreme state before compression and a second extreme crushed state, and the relative position assembled and in which the two hooks are pressing against each other;

FIG. 6 is a cross-sectional view of a second embodiment of a flexible pumping membrane;

of the assembly shown in FIG. 1

FIG. 7 is a cross-sectional view of a second embodiment of a complementary end piece of the flexible pumping membrane shown in FIG. 6;

FIG. 8 is a view, similar to that of FIG. 5, of a part of the two elements illustrated in FIGS. 6 and 7 which are shown in a state corresponding to a low actuation position of the push-button, the pumping bellows being compressed in an intermediate state between a first extreme state before compression and a second extreme crushed state, and the relative position assembled and in which the two hooks are pressing against each other.

### DETAILED DESCRIPTION OF THE INVENTION

For the description of the invention and the understanding of the claims, the vertical and horizontal orientations along the vertical axis V, as indicated in the figures, are adopted without limitation and without reference to terrestrial gravity.

By convention, the vertical axis V is oriented from bottom to top.

### General Description of the Dispensing Assembly According to the Invention Comprising a First Embodiment of the Sealed Assembly

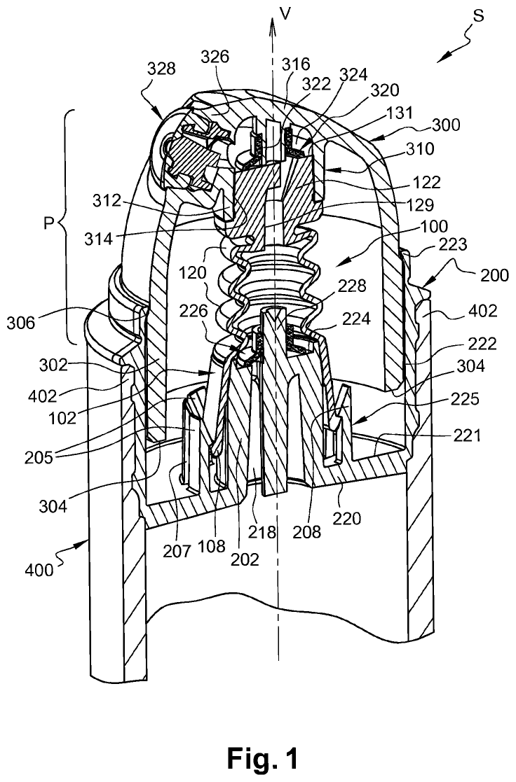

The dispensing system S shown in FIG. 1 comprises an upper pump P and a lower container 400.

The upper pump P comprises a rigid lower end piece 200, a sliding upper push-button 300 and a flexible internal pumping membrane 100 shaped like a bellows.

The open upper end 402 of the lower container 400 is in the form of a rigid tubular portion shaped internally to allow the sealed mounting and securing of the rigid lower end piece 200 on the container 400 to close the latter after it has been filled with product to be dispensed.

The rigid end piece 200 is in the shape of a cylindrical jar which—in a non-limiting fashion—is produced here by molding into a single part.

The rigid end piece 200 comprises a bottom wall 220 and a tubular side wall 222 that extends the bottom wall 220 at its periphery and which extends vertically upward.

The side wall 222 is externally shaped in a manner complementary to the inner shape of the open upper end 402 of the lower container 400.

Here the bottom wall 220 is of substantially planar and horizontal annular shape and extends centrally and axially upward by a central chimney 202 of a generally tubular shape, here centered on the axis V.

As a non-limiting example, the rigid end piece 200 comprises an annular (cylindrical tubular) lateral skirt 225 which extends axially upward from the upper face 221 of the bottom wall 220, here approximately over half the height of the central chimney 202.

As a non-limiting example, the lateral skirt 225 is here angularly divided into a plurality of angular sectors 205 separated by regularly distributed axial slots 207 (see FIG. 1).

The central chimney 202 comprises axial channel 218 to allow the product through, which opens into the horizontal annular upper face 224 of the central chimney.

The upper end of the axial channel 218 is closed by a flexible check valve 226 of known design that is carried by a central axial pin 228 that extends vertically above the horizontal annular upper face 224 of the central chimney 202.

In the open position of the flexible check valve 226, the axial channel 218 opens into the dispensing chamber C formed inside the flexible pumping membrane 100.

At its lower part, the push-button 300 comprises a cylindrical lateral skirt 302 delimited axially downward by a lower annular edge 304 and by an upper shoulder 306 projecting radially outwards.

The lateral skirt 302 of the push-button 300 is guided in axial sliding inside the side wall 222 of the rigid end piece 200, between a high rest position in which its upper shoulder 306 is in axial abutment upward against an upper shoulder 223 protruding radially inward from the side wall 222 of the rigid end piece 200, and a low actuation position (not shown in the figures) in which the lower annular edge 304 is in abutment against a zone facing the upper face 221 of the bottom wall 220 of the rigid end piece 200.

At its upper part, the push-button comprises a rigid end piece 310 for sealingly securing the upper end section 122 of the flexible membrane 100, which comprises a central chimney 312 which extends axially downward inside the push-button 300.

This chimney 312 delimits an inner cylindrical housing 314 wherein the upper end section 122 of the flexible membrane 100 is clamped and is secured thereto in a sealed manner.

The upper end section 122 of the flexible membrane 100 comprises an axial central passage 129 for the product to go through, which opens into the horizontal annular upper face 131 of the section 122.

The upper end of the axial channel 129 is closed by a flexible check valve 320 of known design which is carried by a central axial pin 322 which—from the upper actuation wall 316 of the push-button 300—protrudes vertically downward above the horizontal annular upper face 131 of the upper end section 122.

When the flexible check valve 320 is in the open position, the axial channel 129 opens into an upper cavity 324 which is connected to a product-dispensing spout 326 which is provided with an annular check valve 328 for closing off the outlet port of the dispensing spout 326.

Before mounting, the flexible walls of the flexible check valves 226 and 320 are each in the form of a cone. These flexible walls are deformed during the mounting of the flexible check valves 226, 320 on the pins 228, 322 by pressing and constraining the inner face of the large base of the cone on the facing annular face 224, 131 respectively.

### Description of the First Embodiment of the Sealed Assembly Comprising the Lower Section of the Flexible Pumping Membrane and the Rigid End Piece

In the embodiment illustrated in FIGS. 1 to 5 and by way of non-limiting example, the flexible pumping membrane 100 and the rigid end piece 200 are two rotationally symmetrical parts which have a general design symmetry around the vertical central axis V, and all of the parts, portions or sections called tubular, cylindrical, conical or frustoconical are of generally circular cross-section(s).

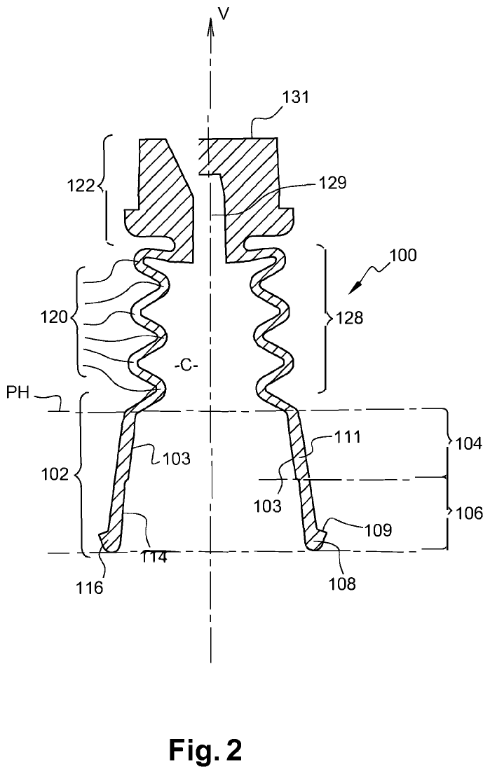

The flexible pumping membrane 100 is produced in one piece by molding and, as can be seen in particular in FIG. 2, the flexible pumping membrane 100, which is in this case shaped like a pumping bellows, successively comprises, vertically from bottom to top:
the upper end section 122 for securing the flexible pumping membrane 100 to the upper push-button 300 which is in this case shaped as a securing block;
a main central portion 128 in this case shaped as a consecutive-bend bellows 120;
and the lower end section 102 for securing the flexible pumping membrane 100 to the rigid end piece 200, which is a flexible tubular wall section which extends the main central pumping portion 128 axially downward.

The main central portion 128 of the pumping bellows can be compressed before assembly, between a first state or extreme position before compression and a second state or extreme “crushed” position wherein all the folds 120 are in compression contact against one another.

At the end of the various operations and steps of assembling the dispensing system, the compression state of the pumping bellows 100 is modulated between two intermediate states or positions located between the first state or extreme position before compression and the second state or extreme crushed position.

The first intermediate state or position is associated with the high rest position of the push-button 300, while the second state or intermediate position is associated with the low actuation position of the push-button relative to the rigid end piece.

The flexible tubular wall section 102 comprises successively and axially from top to bottom:
an downward-flared upper portion 104 of the flexible tubular wall;
an intermediate portion 106 of the flexible tubular wall which—in a non-limiting fashion—
here has a downward-flared frustoconical shape which extends in the extension of the upper portion 104;
and a first hook 108 which here is arranged at the lower end of the tubular wall section 102.

The upper portion 104 consists of an axial upper wall 111 that comprises a downward-flared frustoconical inner surface 103. In particular in its part delimited by the concave inner surface 103, the thickness of the upper axial wall 111 is greater than the thickness of the bellows-shaped main central portion 128 and the intermediate portion 106 of the tubular wall.

The half-angle at the apex of the frustoconical concave inner surface 103 is less than or equal to 20 (twenty) degrees and preferably equal to 10 (ten) degrees.

The intermediate portion 106 is delimited by an inner surface 114 which here is downward-flared frustoconical concave.

The thickness of the intermediate portion 106 is less than that of the upper portion 104 that it extends axially downward.

The first hook 108 is in the form of an annular bead or rib which, in the horizontal direction D indicated in the figures, extends horizontally outward.

The first hook 108 comprises an active annular retaining face 109 oriented vertically upward.

The annular face 109 here is downward-flared frustoconical and its half-angle at the apex is greater than or equal to 60 (sixty) degrees and preferably equal to 70 (seventy) degrees.

The first hook 108 also comprises an upward-flared frustoconical annular ramp 116, the half-angle of the apex of which is preferably equal to 25 (twenty-five) degrees.

Vertically from top to bottom, the central chimney 202 of the rigid end piece 200 successively comprises:
an upper portion 204 which extends from the upper end of the chimney and which comprises a convex outer surface 203 in a downward-flared frustoconical shape which is able to sealingly mate with the concave inner surface 103 of the tubular wall section 102;
an intermediate portion 206 which comprises a convex external face 214 which, in a non-limiting fashion, is here generally cylindrical;
and a lower portion 207 for connecting the central chimney 202 to the lower wall 220 of the rigid end piece 200.

The half-angle at the apex of the frustoconical convex outer surface 203 is equal to the half-angle at the apex of the frustoconical concave inner surface 103 and is therefore equal to 10 (ten) degrees.

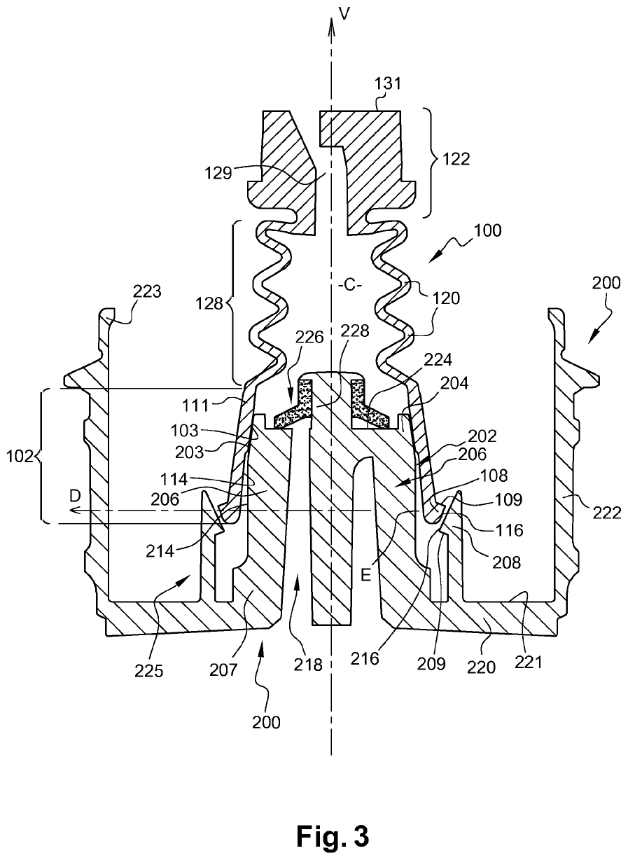

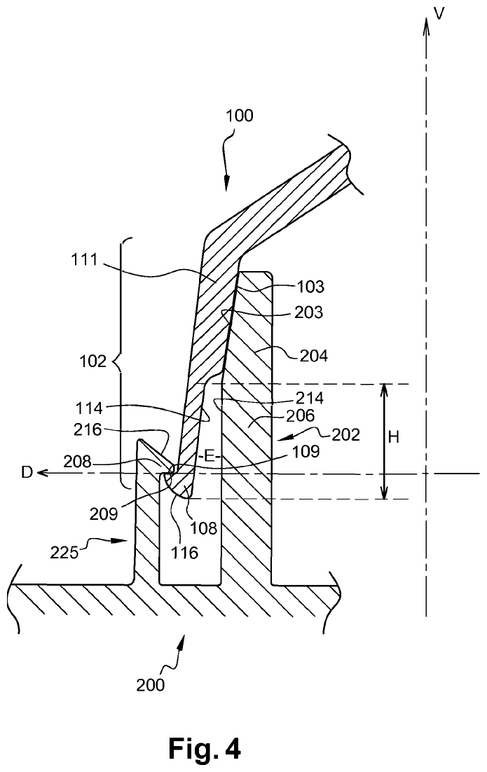

As can be seen in FIGS. 3 and 4, when the two complementary concave 103 and convex 203 frustoconical surfaces are in contact, the outer face 214 of the intermediate portion 206 is distant from the inner face 114 of the intermediate portion 106 of the flexible tubular wall section 102.

There is thus a space E between these two faces 114 and 214 which extends opposite the entire axial height “H” of the intermediate portion 106 of the flexible tubular wall section 102.

In cross-section, the space E here is generally rectangular in shape.

The rigid end piece 200 comprises a second hook 208 which here is arranged at the upper end of the lateral skirt 225.

The second hook 208 is in the form of an annular bead or rib which, in the horizontal direction D indicated in the figures, extends horizontally inward towards the axis V and the first hook 108.

The first hook 108, the lateral skirt 225 and the second hook 208 are of generally annular shape.

The second hook 208 comprises an active annular retaining face 209 oriented vertically downward.

The annular face 209 here is downward-flared frustoconical and its half-angle at the apex is substantially equal to that of the first hook 108 and is preferably equal to 70 (seventy) degrees.

The second hook 208 also comprises an upward-flared frustoconical annular ramp 216, and its half-angle at the apex of which is preferably equal to 25 (twenty-five) degrees. During assembly, this ramp 216 is able to mate with the annular ramp 116 of the first hook 108.

In the embodiment illustrated in the figures and in particular in FIGS. 3 and 4, in the horizontal direction D oriented outward from the vertical axis V, the assembly successively comprises the rigid central chimney 202, the flexible tubular wall section 102 with its first hook 108 which is oriented outward, and the second hook 208 which is oriented inward and which is arranged at the upper end of the rigid lateral skirt 225.

The second hook 208 surrounds the first hook 108.

The pumping membrane 100, and in particular the tubular wall section 102 thereof, which makes it possible to assemble and secure here the lower end of the pumping membrane 100 on the rigid end piece 200, is made of a flexible material, preferably slightly elastic, for example elastically deformable by 5%. and beyond in elongation.

This flexible material is elastically deformable beyond 5% (five percent) of elongation.

By convention, it is specified that, after elastic deformation; the elastically deformable material returns to its initial state and to its initial shape.

As a non-limiting example, the constituent material of the pumping membrane 100 is low-density polyethylene (LDPE), the density of which is less than or equal to 0.900 or 0.900 g/cm³.

For example, the “AFFINITY™” PL 1280 G material can be chosen which is a polyolefin plastomer (POP) produced using “INSIITE™ from Dow Plastics”.

The combined characteristics of the value of the angle at the apex of the concave inner surface 103, of the value of the angle of the annular ramp 116, 216, of the thickness of the flexible tubular wall forming the section 102, of the space E delimited by the faces 114 and 214, of the properties of the material wherein the flexible pumping membrane 100 is made, and in particular of its flexible tubular wall section 102, make it possible to carry out the assembly and the securing of the flexible tubular wall section 102, resulting in the assembled state shown in FIG. 4.

In this state, the active retaining face 109 belonging to the first hook 108 and oriented upward and the complementary second active retaining surface 209 of the second hook 208 are in contact with each other; the two complementary frustoconical annular surfaces of convex outer sealing 203 and inner concave sealing 103 are sealingly pressed together.

### Description of the Method for Assembling the Pump and the Dispensing System

The assembly of the main components of the pump P is achieved as follows.

During a first step, after the assembly of the flexible check valve 320 on the pin 322, the upper end section 122 of the flexible membrane 100 is secured by inserting it axially into the housing 314.

The sub-assembly thus produced is then mounted on the rigid end piece 200, the central chimney 202 of which has previously been equipped with the flexible check valve 226 by mounting on the pin 228.

The mounting is carried out by movement of the push-button 300—and therefore of the flexible membrane 100 which is already attached—relative to the rigid end piece 200 by axially inserting the lateral skirt 302 of the push-button 300 into the side wall 222 of the rigid end piece 200 until the shoulder 223 passes axially through the shoulder 306.

During movement, the tubular wall bottom section 102 covers and progressively surrounds the central chimney 202, in this case at least its upper portion 204 and its intermediate portion 206.

The dimensions and in particular the relative vertical positions of the different portions of the two elements are such that the relative movement leads to an intermediate relative axial position illustrated in FIG. 3 in which the concave frustoconical inner surface 103 of the tubular wall section 102 is in contact with the convex frustoconical outer surface 203.

From this relative axial position, the concave frustoconical inner surface 103 of the tubular wall section 102 bears, along the vertical axis “V” on the convex frustoconical outer surface 203.

From this position, the relative movement is continued by moving the push-button axially downward relative to the rigid end piece 200.

This movement leads to the ramp 116 coming into contact with the first hook 108 against the ramp 216 of the second hook 208.

The continuation of the axial travel towards the bottom of the section 102 relative to the rigid end piece 200 causes the mating of the two ramps 116 and 216 which causes a deformation of the intermediate portion 106 of the tubular wall section 102.

This deformation combined with the axial displacement allows the axial crossing of the second hook 208 by the first hook 108.

In a non-limiting fashion, according to a complementary aspect, the crossing can be facilitated by combining the axial movement with a rotational movement of the push-button 300—flexible membrane 100 assembly relative to the rigid end piece 200.

To guarantee this crossing and the clipping of the two hooks 108 and 208, the push-button 300 can be pushed to its low actuation position in which the lower annular edge 304 abuts against the area facing the upper face 221 of the bottom wall 220 of the rigid end piece 200.

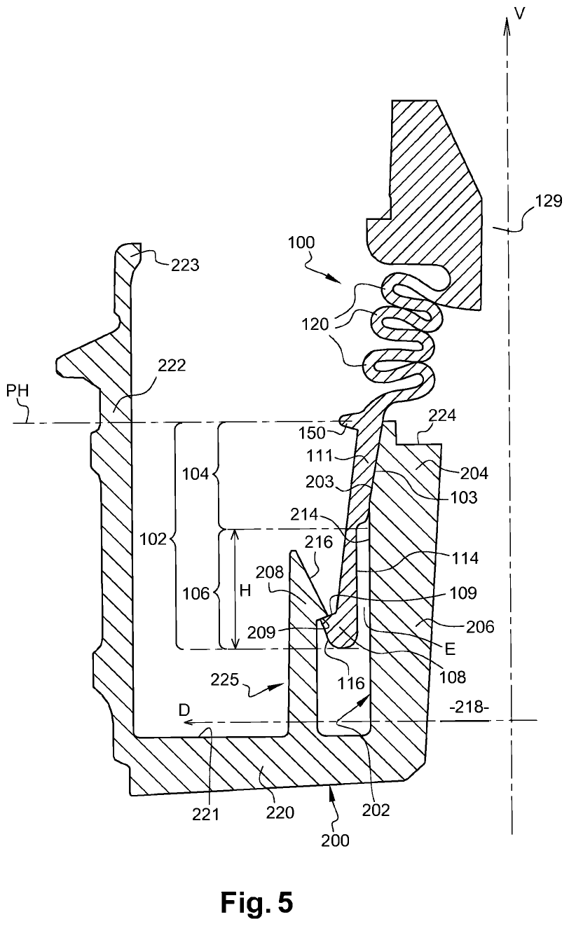

As shown in FIG. 5, in the low actuation position of the push-button 300, the pumping bellows is compressed in an intermediate state between a first extreme state before compression and a second extreme crushed state.

Surprisingly, this intermediate compression state or position induces a bearing force of the flexible tubular wall section 102 on the central chimney 202 which is sufficient to simultaneously allow the axial crossing of the second hook 208 by the first hook 108, and the sealing of the two complementary frustoconical surfaces, the concave inner surface 103 and convex outer surface 203, including when the chamber inside the bellows is subjected to high overpressure up to 2 (two) bars.

When an axial force is no longer being applied to the push-button, the compressed bellows expands and ensures its function of resiliently returning the push-button 300 to its high rest position.

As can be seen in FIG. 4, the two complementary annular surfaces 109 and 209 then remain in mutual abutment without play and the two complementary frustoconical surfaces, the concave inner surface 103 and convex outer surface 203, are pressed together sealingly.

Thus, when the push-button 300 is mounted on the rigid end piece 200, the design according to the invention makes it possible to automatically carry out the securing by a sealed connection of the flexible membrane section 102 onto the end piece 200.

In a known manner, after the assembly of the pump P, the assembly of the system S continues by mounting the pump P on the upper end of the container 400 previously filled with the product.

This step is carried out by fitting the rigid end piece 200—also called a hoop—in the open upper end 402 of the lower container 400.

In addition, as shown in FIG. 5, the upper portion 104 comprises a stiffening ring 150 which extends radially outward relative to the vertical axis V in a horizontal plane PH, located at the upper end of this upper portion 104.

### Variants

As a variant not shown and without departing from the scope of the invention, it is possible to reverse the orientation of the two hooks 108 and 208. According to the horizontal direction D, the assembly then successively comprises the rigid central chimney 202, the second hook 208 which is oriented outward, then the flexible tubular wall section 102 with its first hook 108 which is oriented inward. The second hook 208 which is oriented outward and which is arranged at the upper end of the rigid lateral skirt 225 is then surrounded by the first hook 208.

As a variant not shown and without departing from the scope of the invention, it is also possible to vertically reverse the arrangement of the means for assembling and securing the two ends of the flexible membrane and to allow the automatic assembly and securing of the upper end of the flexible membrane 100 by designing the end piece 310 and the upper end section 122 according to the invention and then by performing the assembly of the pump by starting with the securing of the lower end section 102 in a complementary housing of the lower end piece 200.

### Description of the Second Embodiment of the Sealed Assembly Comprising the Lower Section of the Flexible Pumping Membrane and the Rigid End Piece

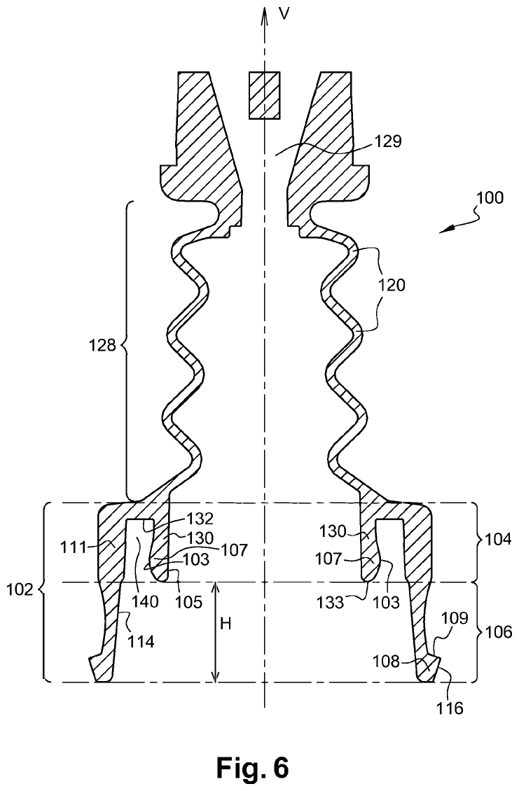

The second embodiment illustrated in FIGS. 6 to 8 will be described via comparison and additions with respect to the first embodiment.

In the following description, identical, similar or analogous elements to those described with reference to FIGS. 1 to 5 will be referred to by the same reference numbers.

To produce the sealed assembly according to the invention and keep said upper portion 104 of the flexible tubular wall section 102 pressed, along the vertical axis V, on the upper portion 204 of the central chimney, the sealing function and pressing are here ensured separately by the mating of the two sealing surfaces and, on the other hand, by the pressing together of the two bearing surfaces.

To this end, as can be seen in FIG. 6, said upper portion 104 of the flexible tubular wall section 102 successively comprises, in a horizontal direction D oriented outward from the central axis V, a first inner tubular axial bushing 130, and the upper axial wall 111 that is arranged radially outward relative to the socket 130.

By way of non-limiting example, the upper axial wall is in the form of an outer tubular axial bushing with respect to the inner bushing 130.

The bushing 130 and upper axial wall 111 are coaxial along the vertical axis V.

The inner bushing 130 is delimited laterally by an inner concave cylindrical surface 105 and by an outer convex cylindrical surface 103 which constitutes the first sealing surface within the meaning of the invention.

As a non-limiting example, the surface 103 is here shaped with a bulge 107 forming a seal.

The inner bushing 130 is delimited axially downward by a free end lower edge 133.

The lower edge 133 extends substantially in the horizontal plane which delimits the upper section relative to the intermediate section 106.

The inner bushing 130 and the upper axial wall 111 delimit between them a tubular axial housing 140 which is open axially downward and which is delimited axially upward by an annular face 132 which constitutes a first bearing face within the meaning of the invention.

The bearing face 132 here extends in a horizontal plane.

This first bearing face 132 is oriented downward and is delimited in the horizontal direction D between the inner tubular axial bushing 130 and the upper axial wall 111.

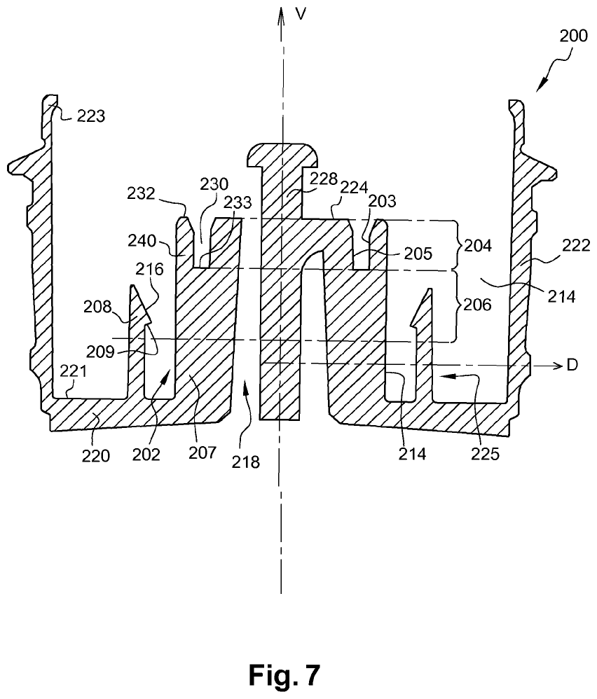

In a complementary manner and as can be seen in FIG. 7, the central chimney 202 of the end piece 200 comprises a tubular axial housing 230 centered on the vertical axis V and which is open axially upward by opening out into the horizontal annular upper face 224 of the central chimney 202.

The housing 230 is delimited laterally by an inner convex cylindrical surface 205 and by an outer concave cylindrical surface 203 which constitutes the second sealing surface within the meaning of the invention which is able to mate with the first sealing surface 103.

The housing 230 is delimited axially downward by a bottom which here is an annular face 233.

The bottom 233 extends substantially in the horizontal plane which delimits the upper portion 204 relative to the portion 206 of the central chimney 202.

In the upper part 204 of the central chimney, the housing 230 delimits a radially outer tubular axial part 240 which is delimited axially upward by a free end annular edge 232 which constitutes a second bearing face within the meaning of the invention which is able to mate with the first bearing face 132.

The annular edge 232 here extends in the horizontal plane of the horizontal annular upper face 224 of the central chimney 202.

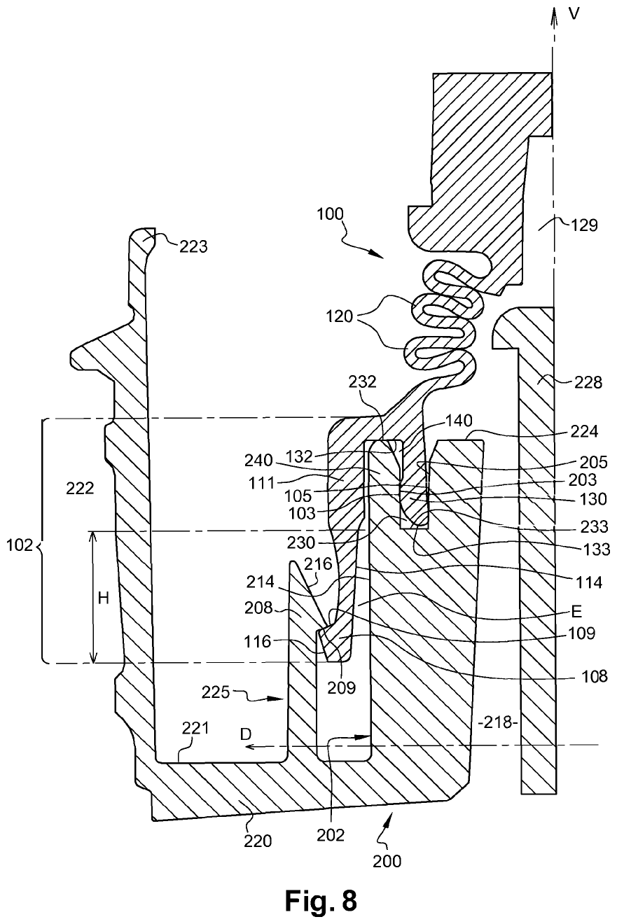

In the assembled position and as can be seen in FIG. 8, the inner bushing 130 is received axially in the housing 230.

The sealing is here ensured by the sealed pressing of the first sealing surface 103, and in particular of the bulge 107, against the portion facing the second sealing surface 203.

The bearing faces 132 and 232 are pressed together along the vertical axis V.

There is an axial clearance between the lower edge 133 and the bottom 233.

The assembly of the main components of the pump P is done in the same way as that described with reference to the first embodiment.

As shown in FIG. 8, in the low actuation position of the push-button 300, the pumping bellows is compressed in an intermediate state between a first extreme state before compression and a second extreme crushed state.

Surprisingly, this intermediate compression state or position induces a bearing force of the flexible tubular wall section 102 on the central chimney 202 which is sufficient to simultaneously allow the axial crossing of the second hook 208 by the first hook 108, and the axial pressing of the two bearing surfaces 132 and 232, including when the chamber inside the bellows is subjected to high overpressure up to 2 (two) bars.

When an axial force is no longer being applied to the push-button, the compressed bellows expands and ensures its function of resiliently returning the push-button 300 to its high rest position.

As can be seen in FIG. 8, the bearing faces 132 and 232 as well as the two complementary annular surfaces 109 and 209 of the hooks 108 and 208 then respectively remain pressed together without play and the two complementary convex 103 and concave 203 sealing surfaces are pressed together sealingly.

Thus, when the push-button 300 is mounted on the rigid end piece 200, the design according to the invention makes it possible to automatically carry out the securing by a sealed connection of the flexible membrane section 102 onto the end piece 200.

### Variants

As a variant not shown and without departing from the scope of the invention, it is possible to reverse the orientation of the two hooks 108 and 208. According to the horizontal direction D, the assembly then successively comprises the rigid central chimney 202, the second hook 208 which is oriented outward, then the flexible tubular wall section 102 with its first hook 108 which is oriented inward. The second hook 208 which is oriented outward and which is arranged at the upper end of the rigid lateral skirt 225 is then surrounded by the first hook 208.

As a variant not shown and without departing from the scope of the invention, it is also possible to vertically reverse the arrangement of the means for assembling and securing the two ends of the flexible membrane and to allow the automatic assembly and securing of the upper end of the flexible membrane 100 by designing the end piece 310 and the upper end section 122 according to the invention and then by performing the assembly of the pump by starting with the securing of the lower end section 102 in a complementary housing of the lower end piece 200.

1. A sealed assembly, along a vertical central axis (V) oriented from bottom to top,
of a flexible tubular wall section forming the lower end of an upper flexible membrane capable of being compressed along the vertical axis (V) of the assembly, and of a rigid end piece,
characterized in that:
a) the flexible tubular wall section comprises, successively and axially from top to bottom along the axis (V):
a1) an upper portion with at least one first sealing surface;
a2) an intermediate portion with an inner face of the flexible tubular wall;
a3) a first retaining hook arranged at the lower end of the flexible tubular wall section,
and in that:
b) the rigid end piece comprises:
b1) a central chimney which is capped and at least partially surrounded by the flexible tubular wall section and which comprises successively and axially from top to bottom along the axis (V):
b11) an upper portion in which the central chimney has a second sealing surface that mates with the first sealing surface of the upper portion,
b12) an intermediate portion with an outer face which is distant from the inner face of the intermediate portion of the flexible tubular wall section, so as to provide a space (E) between the inner face and the outer face;
b2) and a second hook which mates with the first hook to hold the upper portion of the flexible tubular wall section pressed, along the vertical axis (V), on the upper portion of the central chimney.

2. The sealed assembly according to claim 1, characterized in that:
the upper portion of the flexible tubular wall section consists of an upper axial wall, an inner face of which in the form of a downward-flared truncated cone is the first sealing surface;
the upper portion of the central chimney has a downward-flared truncated cone shape, a lateral face of which is the second sealing surface;
the first sealing surface rests on the second sealing surface, along the vertical axis (V).

3. The sealed assembly according to claim 1, characterized:
in that the upper portion of the flexible tubular wall section comprises successively, in a horizontal direction (D) oriented outward from the vertical axis (V):
an inner tubular axial bushing, a lateral face of which is the first sealing surface;
and the upper axial wall providing the connection with the intermediate portion of the flexible tubular wall section;
in that the upper portion of the central chimney comprises a tubular axial housing open axially upward, wherein the inner tubular axial bushing is axially housed, a lateral face of which is the second sealing surface;
and in that:
the upper portion of the flexible tubular wall section comprises a first bearing face oriented downward and delimited in said horizontal direction (D) between the inner tubular axial bushing and the upper axial wall;
the upper portion of the central chimney comprises a second bearing face oriented upward;
and the first bearing face is supported on the second bearing face along the vertical axis (V).

4. The sealed assembly according to claim 1, characterized in that the first hook comprises a frustoconical annular retaining face oriented upward and flared downward which is in abutment, along the vertical axis (V), against a complementary frustoconical retaining annular face, oriented downward and flared downward, belonging to the second hook.

5. The sealed assembly according to claim 1, characterized in that the thickness of the upper axial wall is greater than the thickness of the intermediate portion of the flexible tubular wall section.

6. The sealed assembly according to claim 1, characterized in that the space (E) between said internal face and said external face extends across from the entire axial height (H) of the intermediate portion of the flexible tubular wall section.

7. The sealed assembly according to claim 2, characterized in that the upper portion of the flexible tubular wall section comprises an outer stiffening ring which is arranged axially in a horizontal plane (PH) perpendicular to the vertical axis (V) located at the upper end of this upper portion of the flexible tubular wall section.

8. The sealed assembly according to claim 1, characterized in that:
the intermediate portion of the flexible tubular wall section is delimited by a downward-flared frustoconical inner face; and
the intermediate portion of the central chimney is delimited by a cylindrical external lateral face.

9. The sealed assembly according to claim 2, characterized in that the half-angle at the apex of said inner surface and said outer surface are equal and less than or equal to twenty degrees.

10. The sealed assembly according to claim 1, characterized in that the first hook is a continuous annular hook and the second hook is an annular hook divided into several sectors.

11. The sealed assembly according to claim 1, characterized in that, in a horizontal direction (D) oriented outward from the vertical axis (V) of the assembly, the assembly successively comprises the first hook which is oriented outward, and the second hook which is oriented inward.

12. The sealed assembly according to claim 11, characterized in that it comprises at least one annular ramp formed on the first hook and/or on the second hook to cause a deformation of the intermediate portion of the flexible tubular wall section allowing axial crossing of the second hook by the first hook during the assembly of the flexible tubular wall section and the rigid end piece.

13. The sealed assembly according to claim 1, characterized in that the rigid end piece comprises a tubular skirt which surrounds the central chimney, and in that the second hook is arranged at an upper end of this skirt.

14. The sealed assembly according to claim 13, characterized in that the lateral skirt and the second hook are divided into several sectors separated by axial slits.

15. The sealed assembly according to claim 1, characterized in that the upper flexible membrane is shaped like a consecutive-bend bellows capable of being compressed along the axis (V) of the assembly.

16. The sealed assembly according to claim 1, characterized in that the upper flexible membrane is made of a low-density polyethylene (LDPE) the density of which is less than or equal to 0.900.

17. An airless dispensing system for a liquid or paste product which comprises a lower container that contains the product and an upper pump (P) that is mounted on the container and that comprises:
a rigid end piece that is mounted at the upper end of the container and comprises a central chimney provided with an axial product passage channel;
a push-button that is slidably mounted relative to the rigid end piece between a high rest position and a low actuation position, and the upper part of which comprises an outlet for the product;
and a flexible membrane, shaped like a pumping bellows for the product, an upper end section of which is secured to the push-button by a sealed connection and a lower end section of which is fixed to the rigid end piece,
characterized in that said lower end section and the rigid end piece form a sealed assembly according to claim 1.

18. A method for the sealed assembly of a dispensing system according to claim 17, characterized in that it comprises the successive steps consisting of producing the pump (P):
e1) by axially assembling the flexible membrane, shaped like a pumping bellows, and the push-button by securing its upper end section to the push-button;
e2) and by axially assembling the rigid end piece and the push-button by automatically performing the assembly and securing said section of the flexible membrane by a sealed connection on the rigid end piece during the mounting of the push-button on the rigid end piece, by axial crossing of the second hook by the first hook, by placing the upper portion of the flexible tubular wall section bearing, along the vertical axis (V), on the upper portion of the central chimney and by making the first sealing surface and the second sealing surface mate in a sealed manner.
